(19) United States
(12) Patent Application Publication
(10) Pub. No.: US 2023/0110458 A1
(43) Pub. Date: Apr. 13, 2023

(54) METHOD AND SYSTEM FOR MATCHING INVESTORS WITH COMPANIES

(71) Applicant: JPMorgan Chase Bank, N.A., New York, NY (US)

(72) Inventors: Simerjot KAUR, Jersey City, NJ (US); Ivan BRUGERE, Palo Alto, CA (US); Andrea STEFANUCCI, Hoboken, NJ (US); Armineh NOURBAKHSH, Pittsburgh, PA (US); Sameena SHAH, Scarsdale, NY (US); Manuela VELOSO, New York, NY (US)

(73) Assignee: JPMorgan Chase Bank, N.A., New York, NY (US)

(21) Appl. No.: 17/960,328

(22) Filed: Oct. 5, 2022

Related U.S. Application Data
(60) Provisional application No. 63/253,734, filed on Oct. 8, 2021.

(51) Int. Cl. G06Q 40/06

(52) U.S. Cl. CPC G06Q 40/06

(57) ABSTRACT

A method for generating a recommendation for a potential investment is provided. The method includes: receiving first information that relates to each respective company from among a plurality of companies; generating, for each respective company based on the first information, a first vector representation; receiving second information that relates to each respective investor from among a plurality of investors; generating, for each respective investor based on the second information, a second vector representation; using the first vector representations and the second vector representations as inputs to an artificial intelligence-based algorithm in order to calculate a respective similarity metric for each respective company-investor pair; generating the recommendation for the potential investment based on the calculated similarity metrics; and generating an explanation for the recommendation.

### CROSS-REFERENCE TO RELATED APPLICATIONS

This application claims priority benefit from U.S. Provisional Application No. 63/253,734, filed Oct. 8, 2021, which is hereby incorporated by reference in its entirety.

### BACKGROUND

### 1. Field of the Disclosure

This technology generally relates to methods and systems for providing recommendations to investors, and more particularly to methods and systems for automating a process of matching investors with companies by using a parameterized explanation generation engine in combination with an artificial intelligence (AI)-based algorithm that implements a deep learning technique.

### 2. Background Information

Matching companies to investors, and investors to companies has been a long-standing problem in investment banking. Such matchmaking exercise is extremely beneficial to both investors and startups/companies who are looking for funding. On one end, it helps investors identify which companies to invest in, and on the other end, it helps provide guidance to startup/companies on which investors to approach when they are looking to raise funding. Moreover, in financial organizations, this match-making can have direct financial consequences, for both investors and companies. Hence the ability to explain, why a particular investment opportunity is beneficial to investors and why a startup should approach a particular investor for funding, becomes critical.

However, matching investor and companies and providing explanations is typically very expensive, as it involves manual sourcing of companies and investors, analyzing their historical track records, their performance and preferences, and hence becomes a tedious task involving significant amount of manual labor. Further, it also brings about human errors and the results are often dependent on the individual experience and expertise of humans involved in this process.

Accordingly, there is a need for a method for automating a process of matching investors with companies by using a parameterized explanation generation engine in combination with an artificial intelligence (AI)-based algorithm that implements a deep learning technique.

### SUMMARY

The present disclosure, through one or more of its various aspects, embodiments, and/or specific features or sub-components, provides, inter alia, various systems, servers, devices, methods, media, programs, and platforms for methods and systems for automating a process of matching investors with companies by using a parameterized explanation generation engine in combination with an artificial intelligence (AI)-based algorithm that implements a deep learning technique.

According to an aspect of the present disclosure, a method for generating a recommendation for a potential investment is provided. The method is implemented by at least one processor. The method includes: receiving, by the at least one processor, first information that relates to each respective company from among a plurality of companies; generating, for each respective company based on the first information by the at least one processor, a first vector representation; receiving, by the at least one processor, second information that relates to each respective investor from among a plurality of investors; generating, for each respective investor based on the second information by the at least one processor, a second vector representation; using, by the at least one processor, the first vector representations and the second vector representations to calculate a respective similarity metric for each respective pair of one company from among the plurality of companies and one investor from among the plurality of investors; generating, by the at least one processor, the recommendation for the potential investment based on the calculated similarity metrics; and generating, by the at least one processor, an explanation that includes at least one reason that relates to the recommendation.

The first information may include, for each respective company, at least one from among a description, an industry focus, a year during which the respective company was founded, and a location.

For at least one respective company from among the plurality of companies, the first information may further include information that relates to at least one deal executed by the at least one respective company, including at least one from among a type of series rounds performed by the at least one respective company, an amount of capital raised, and a date of the at least one deal.

The second information may include, for each respective investor, at least one from among information that relates to a funding style, information that relates to an industry preference, and a location.

The using of the first vector representations and the second vector representations to calculate each respective similarity metric may include applying an artificial intelligence (AI)-based algorithm that determines, for each respective pair of one company from among the plurality of companies and one investor from among the plurality of investors, a first score that is based on a content-based model and a second score that is based on a collaborative-based model, and then calculates the respective similarity metric by combining the first score with the second score.

The determining of the first score may include calculating a cosine similarity function based on the first vector representation of the one company and respective first vector representations that correspond to companies in which the one investor has previously invested.

The determining of the second score may include calculating a cosine similarity function based on the second vector representation of the one investor and respective second vector representations that correspond to investors that have previously invested in the one company.

The calculating of the respective similarity metric may further include: when the second score exceeds a predetermined threshold, multiplying the first score by a predetermined first weight to obtain a first product and multiplying the second score by a predetermined second weight to obtain a second product and then adding the first product to the second product; and when the second score does not exceed the predetermined threshold, using the first score as the respective similarity metric.

The generating of the explanation may include: determining a first partial explanation based on a similarity between the one investor and at least one other investor that has previously invested in the one company; determining a second partial explanation based on a similarity between the one company and at least one other company in which the one investor has previously invested; determining a third partial explanation based on a description of the one company; and generating the explanation based on a combination of the first partial explanation, the second partial explanation, and the third partial explanation.

According to another exemplary embodiment, a computing apparatus for optimizing a design of an organization is provided. The computing apparatus includes a processor; a memory; and a communication interface coupled to each of the processor and the memory. The processor is configured to: receive, via the communication interface, first information that relates to each respective company from among a plurality of companies; generate, for each respective company based on the first information, a first vector representation; receive, via the communication interface, second information that relates to each respective investor from among a plurality of investors; generate, for each respective investor based on the second information, a second vector representation; use the first vector representations and the second vector representations to calculate a respective similarity metric for each respective pair of one company from among the plurality of companies and one investor from among the plurality of investors; generate the recommendation for the potential investment based on the calculated similarity metrics; and generate an explanation that includes at least one reason that relates to the recommendation.

The first information may include, for each respective company, at least one from among a description, an industry focus, a year during which the respective company was founded, and a location.

For at least one respective company from among the plurality of companies, the first information may further include information that relates to at least one deal executed by the at least one respective company, including at least one from among a type of series rounds performed by the at least one respective company, an amount of capital raised, and a date of the at least one deal.

The second information may include, for each respective investor, at least one from among information that relates to a funding style, information that relates to an industry preference, and a location.

The processor may be further configured to calculate each respective similarity metric by applying an artificial intelligence (AI)-based algorithm that determines, for each respective pair of one company from among the plurality of companies and one investor from among the plurality of investors, a first score that is based on a content-based model and a second score that is based on a collaborative-based model, and then calculates the respective similarity metric by combining the first score with the second score.

The processor may be further configured to determine the first score by calculating a cosine similarity function based on the first vector representation of the one company and respective first vector representations that correspond to companies in which the one investor has previously invested.

The processor may be further configured to determine the second score by calculating a cosine similarity function based on the second vector representation of the one investor and respective second vector representations that correspond to investors that have previously invested in the one company.

The processor may be further configured to calculate the respective similarity metric by: when the second score exceeds a predetermined threshold, multiplying the first score by a predetermined first weight to obtain a first product and multiplying the second score by a predetermined second weight to obtain a second product and then adding the first product to the second product; and when the second score does not exceed the predetermined threshold, using the first score as the respective similarity metric.

The processor may be further configured to generate the explanation by: determining a first partial explanation based on a similarity between the one investor and at least one other investor that has previously invested in the one company; determining a second partial explanation based on a similarity between the one company and at least one other company in which the one investor has previously invested; determining a third partial explanation based on a description of the one company; and generating the explanation based on a combination of the first partial explanation, the second partial explanation, and the third partial explanation.

According to yet another exemplary embodiment, a non-transitory computer readable storage medium storing instructions for generating a recommendation for a potential investment is provided. The storage medium includes executable code which, when executed by a processor, causes the processor to: receive first information that relates to each respective company from among a plurality of companies; generate, for each respective company based on the first information, a first vector representation; receive second information that relates to each respective investor from among a plurality of investors; generate, for each respective investor based on the second information, a second vector representation; use the first vector representations and the second vector representations to calculate a respective similarity metric for each respective pair of one company from among the plurality of companies and one investor from among the plurality of investors; generate the recommendation for the potential investment based on the calculated similarity metrics; and generate an explanation that includes at least one reason that relates to the recommendation.

The first information may include, for each respective company, at least one from among a description, an industry focus, a year during which the respective company was founded, and a location.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for automating a process of matching investors with companies by using a parameterized explanation generation engine in combination with an artificial intelligence (AI)-based algorithm that implements a deep learning technique.

FIG. 4 is a flowchart of an exemplary process for implementing a method for automating a process of matching investors with companies by using a parameterized explanation generation engine in combination with an artificial intelligence (AI)-based algorithm that implements a deep learning technique.

FIG. 5 is an illustration of a problem to be solved by executing a method for automating a process of matching investors with companies by using a parameterized explanation generation engine in combination with an artificial intelligence (AI)-based algorithm that implements a deep learning technique, according to an exemplary embodiment.

FIG. 6 is an illustration of an approach that is taken by a method for automating a process of matching investors with companies by using a parameterized explanation generation engine in combination with an artificial intelligence (AI)-based algorithm that implements a deep learning technique, according to an exemplary embodiment.

FIG. 7 is an illustration of how companies and investors are depicted by using vector representations in a method for automating a process of matching investors with companies by using a parameterized explanation generation engine in combination with an artificial intelligence (AI)-based algorithm that implements a deep learning technique, according to an exemplary embodiment.

FIG. 8 is a step-by-step description of a matching algorithm that is used in a method for automating a process of matching investors with companies by using a parameterized explanation generation engine in combination with an artificial intelligence (AI)-based algorithm that implements a deep learning technique, according to an exemplary embodiment.

FIG. 9 is a histogram of similarity scores for a situation in which historical links exist between paired companies and investors, as determined by applying a method for automating a process of matching investors with companies by using a parameterized explanation generation engine in combination with an artificial intelligence (AI)-based algorithm that implements a deep learning technique, according to an exemplary embodiment.

FIG. 10 is a histogram of similarity scores for a situation in which historical links do not exist between paired companies and investors, as determined by applying a method for automating a process of matching investors with companies by using a parameterized explanation generation engine in combination with an artificial intelligence (AI)-based algorithm that implements a deep learning technique, according to an exemplary embodiment.

FIG. 11 is a chart that shows results of a stability analysis of a method for automating a process of matching investors with companies by using a parameterized explanation generation engine in combination with an artificial intelligence (AI)-based algorithm that implements a deep learning technique, according to an exemplary embodiment.

FIG. 12 is a graph that illustrates the stability analysis information of FIG. 11.

FIG. 13 is a chart that shows information that corresponds to an explainability analysis with respect to a method for automating a process of matching investors with companies by using a parameterized explanation generation engine in combination with an artificial intelligence (AI)-based algorithm that implements a deep learning technique, according to an exemplary embodiment.

FIG. 14 is a chart that shows results of human analysis with high scores as determined by executing a method for automating a process of matching investors with companies by using a parameterized explanation generation engine in combination with an artificial intelligence (AI)-based algorithm that implements a deep learning technique, according to an exemplary embodiment.

FIG. 15 is a chart that shows results of human analysis with low scores as determined by executing a method for automating a process of matching investors with companies by using a parameterized explanation generation engine in combination with an artificial intelligence (AI)-based algorithm that implements a deep learning technique, according to an exemplary embodiment.

FIG. 16 is a step-by-step description of a parameterized explanatory algorithm that is used in a method for automating a process of matching investors with companies by using a parameterized explanation generation engine in combination with an artificial intelligence (AI)-based algorithm that implements a deep learning technique, according to an exemplary embodiment.

FIG. 17 is a chart that shows example results of the parameterized explanatory algorithm of FIG. 16.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

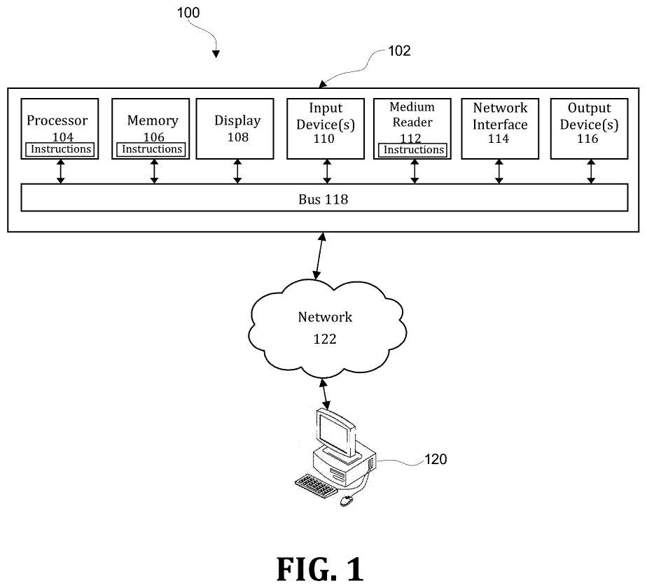

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for automating a process of matching investors with companies by using a parameterized explanation generation engine in combination with an artificial intelligence (AI)-based algorithm that implements a deep learning technique.

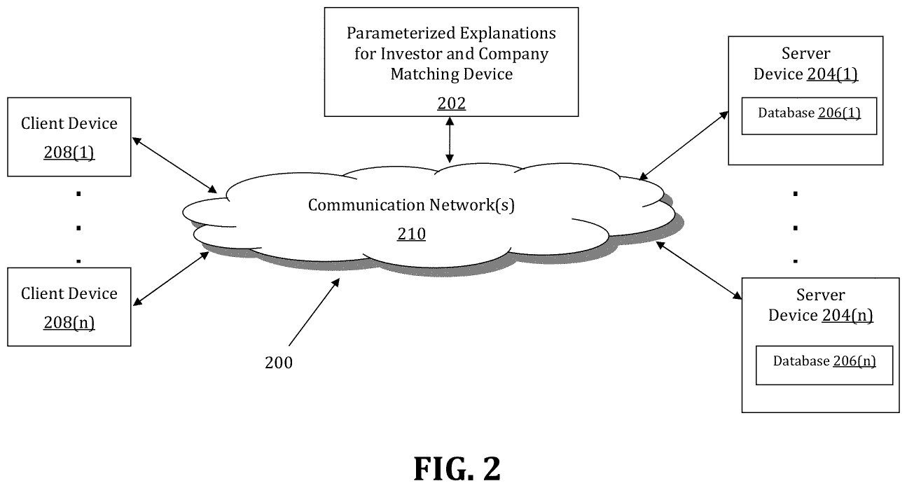

Referring to FIG. 2, a schematic of an exemplary network environment 200 for implementing a method for automating a process of matching investors with companies by using a parameterized explanation generation engine in combination with an artificial intelligence (AI)-based algorithm that implements a deep learning technique is illustrated. In an exemplary embodiment, the method is executable on any networked computer platform, such as, for example, a personal computer (PC).

The method for automating a process of matching investors with companies by using a parameterized explanation generation engine in combination with an artificial intelligence (AI)-based algorithm that implements a deep learning technique may be implemented by a Parameterized Explanations for Investor and Company Matching (PEICM) device 202. The PEICM device 202 may be the same or similar to the computer system 102 as described with respect to FIG. 1. The PEICM device 202 may store one or more applications that can include executable instructions that, when executed by the PEICM device 202, cause the PEICM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the PEICM device 202 itself, may be located in virtual server(s) running in a cloud-based computing environment rather than being tied to one or more specific physical network computing devices. Also, the application(s) may be running in one or more virtual machines (VMs) executing on the PEICM device 202. Additionally, in one or more embodiments of this technology, virtual machine(s) running on the PEICM device 202 may be managed or supervised by a hypervisor.

In the network environment 200 of FIG. 2, the PEICM device 202 is coupled to a plurality of server devices 204(1)-204(n) that hosts a plurality of databases 206(1)-206(n), and also to a plurality of client devices 208(1)-208(n) via communication network(s) 210. A communication interface of the PEICM device 202, such as the network interface 114 of the computer system 102 of FIG. 1, operatively couples and communicates between the PEICM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the PEICM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and PEICM devices that efficiently implement a method for automating a process of matching investors with companies by using a parameterized explanation generation engine in combination with an artificial intelligence (AI)-based algorithm that implements a deep learning technique.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The PEICM device 202 may be a standalone device or integrated with one or more other devices or apparatuses, such as one or more of the server devices 204(1)-204(n), for example. In one particular example, the PEICM device 202 may include or be hosted by one of the server devices 204(1)-204(n), and other arrangements are also possible. Moreover, one or more of the devices of the PEICM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the PEICM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to historical company-specific information and data that relates to investor-specific information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the PEICM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the PEICM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the PEICM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the PEICM device 202, the server devices 204(1)-204(n), or the client devices 208(1)-208(n), for example, may be configured to operate as virtual instances on the same physical machine. In other words, one or more of the PEICM device 202, the server devices 204(1)-204(n), or the client devices 208(1)-208(n) may operate on the same physical device rather than as separate devices communicating through communication network(s) 210. Additionally, there may be more or fewer PEICM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

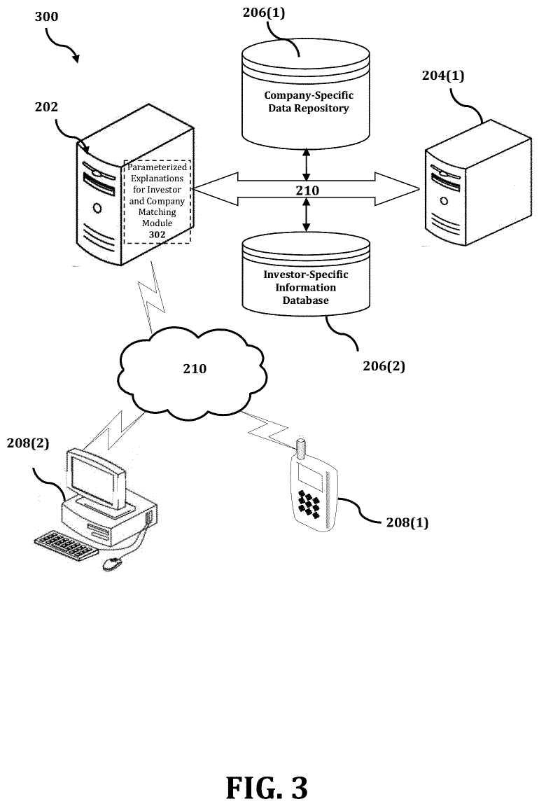

The PEICM device 202 is described and illustrated in FIG. 3 as including a parameterized explanations for investor and company matching module 302, although it may include other rules, policies, modules, databases, or applications, for example. As will be described below, the parameterized explanations for investor and company matching module 302 is configured to implement a method for automating a process of matching investors with companies by using a parameterized explanation generation engine in combination with an artificial intelligence (AI)-based algorithm that implements a deep learning technique.

An exemplary process 300 for implementing a mechanism for automating a process of matching investors with companies by using a parameterized explanation generation engine in combination with an artificial intelligence (AI)-based algorithm that implements a deep learning technique by utilizing the network environment of FIG. 2 is illustrated as being executed in FIG. 3. Specifically, a first client device 208(1) and a second client device 208(2) are illustrated as being in communication with PEICM device 202. In this regard, the first client device 208(1) and the second client device 208(2) may be “clients” of the PEICM device 202 and are described herein as such. Nevertheless, it is to be known and understood that the first client device 208(1) and/or the second client device 208(2) need not necessarily be “clients” of the PEICM device 202, or any entity described in association therewith herein. Any additional or alternative relationship may exist between either or both of the first client device 208(1) and the second client device 208(2) and the PEICM device 202, or no relationship may exist.

Further, PEICM device 202 is illustrated as being able to access a historical company-specific data repository 206(1) and a historical investor-specific information database 206(2). The parameterized explanations for investor and company matching module 302 may be configured to access these databases for implementing a method for automating a process of matching investors with companies by using a parameterized explanation generation engine in combination with an artificial intelligence (AI)-based algorithm that implements a deep learning technique.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the PEICM device 202 via broadband or cellular communication. Of course, these embodiments are merely exemplary and are not limiting or exhaustive.

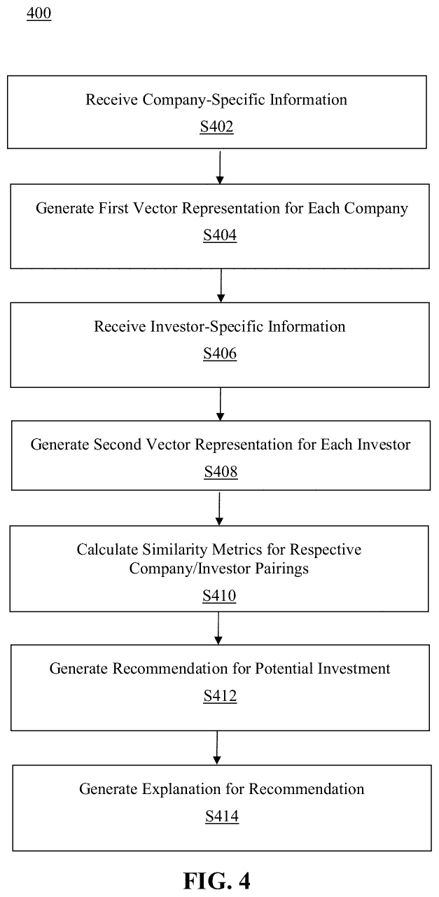

Upon being started, the parameterized explanations for investor and company matching module 302 executes a process for automating a process of matching investors with companies by using a parameterized explanation generation engine in combination with an artificial intelligence (AI)-based algorithm that implements a deep learning technique. An exemplary process for automating a process of matching investors with companies by using a parameterized explanation generation engine in combination with an artificial intelligence (AI)-based algorithm that implements a deep learning technique is generally indicated at flowchart 400 in FIG. 4.

In process 400 of FIG. 4, at step S402, the parameterized explanations for investor and company matching module 302 receives a first set of information that relates to a set of companies that are being considered for potential investments. The information included in the first set of information is company-specific to each respective company included in the set of companies. The company-specific information may include, for example, any one or more of a description of the respective company, an industry focus of the respective company, a founding year of the respective company, and a location of the respective company. The company-specific information may also include information that relates to deals that have been executed by the respective company, such as, for example, a type of series rounds performed by the respective company in connection with a particular deal, an amount of capital raised for a particular deal, and a date of a particular deal. Then, at step S404, the parameterized explanations for investor and company matching module 302 generates a first vector representation for each respective company based on the corresponding company-specific information.

At step S406, the parameterized explanations for investor and company matching module 302 receives a second set of information that relates to a set of investors that are being considered for potential investments with respect to the set of companies. The information included in the second set of information is investor-specific to each respective investor included in the set of investors. The investor-specific information may include, for example, any one or more of a funding style that is preferred by the respective investor, an industry preference of the respective investor, an a location of the respective investor. Then, at step S408, the parameterized explanations for investor and company matching module 302 generates a second vector representation for each respective investor based on the corresponding investor-specific information.

At step S410, the parameterized explanations for investor and company matching module 302 uses the first vector representations for all of the companies included in the set of companies and the second vector representations for all of the investors in the set of investors to calculate a respective similarity metric for each potential company-investor pairing. In an exemplary embodiment, the calculation of the similarity metrics is performed by applying an artificial intelligence (AI)-based algorithm that determines, for each potential company-investor pairing, a first score that is based on a content-based model and a second score that is based on a collaborative-based model, and then combines the first score with the second score to calculate each respective similarity metric.

In an exemplary embodiment, for a particular company-investor pairing, the first score may be determined by calculating a cosine similarity function that is based on the first vector representation of the respective company and first vector representations of other companies in which the particular investor has previously invested. In an exemplary embodiment, for that same particular company-investor pairing, the second score may be determined by calculating a cosine similarity function that is based on the second vector representation of the respective investor and second vector representations of other investors that have previously invested in the particular company.

In an exemplary embodiment, the calculating of a respective similarity metric may be performed based on the following formula. When the second score exceeds a predetermined threshold, multiply the first score by a predetermined first weight to obtain a first product and multiply the second score by a predetermined second weight to obtain a second product, and then add the first product to the second product to obtain the similarity metric; and when the second score does not exceed the predetermined threshold, use the first score as the similarity metric.

At step S412, the parameterized explanations for investor and company matching module 302 generates recommendations for potential investments based on the calculated similarity metrics. Then, at step S414, the parameterized explanations for investor and company matching module 302 generates explanations that correspond to the recommendations. In an exemplary embodiment, for a particular company-investor pairing, the generating of the explanation may include combining several partial explanations, including: a first partial explanation that is based on a similarity between a particular investor and at least one other investor that has previously invested in a particular company; a second partial explanation that is based on a similarity between the particular company and at least one other company in which the particular investor has previously invested; and a third partial explanation that is based on a description of the particular company.

In an exemplary embodiment, in order to overcome limitations of high cost and a need for a human expert with years of experience, the present disclosure describes a method for matching companies and investors in an automated manner by building a deep-learning based investor-company matching recommendation engine. Unlike many e-commerce recommendation systems, such as movie recommendations or book recommendations, where the primary goal is typically to provide good automated recommendations only, in an exemplary embodiment, a recommendation system aimed within the financial domain, such as investor-company matching, should not only provide good recommendations, but must also be capable of providing explanations as to why a particular recommendation is being made. This is critical to ensure real-life adoption of such models. In many instances, a lack of explainability of current deep learning models makes their adoption extremely difficult within the financial domain.

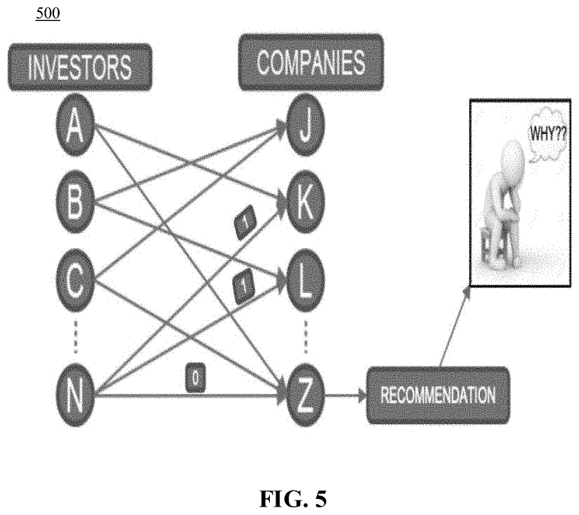

FIG. 5 is an illustration 500 of a problem to be solved by executing a method for automating a process of matching investors with companies by using a parameterized explanation generation engine in combination with an artificial intelligence (AI)-based algorithm that implements a deep learning technique, according to an exemplary embodiment.

FIG. 5 summarizes the problem more formally: Given a set of investors A, B . . . N, and a set of companies J, K, . . . Z, together with investor/company attributes and their historical interactions, can recommendations of new links, i.e., recommendations of new companies to investors, and investors to companies, be made while also providing an explanation for why a particular recommendation has been made?

In an exemplary embodiment, the present disclosure proposes a novel algorithm that leverages recent advances in deep learning to make recommendation engines, and combines such recommendations with a parameterized explanation generation scheme to build an explainable investor-company matching system. In particular, the approach first builds a high-dimensional vector representation for each investor and company using available input data such as their description and their past investments, and subsequently uses these vector representations as inputs to a hybrid content-based and collaborative-based model, in order to generate similarity scores between investors and companies which are used for making recommendations. Further, the outputs generated by the content-based and collaborative-based model are used to extract parameters for a parameterized template based explanatory engine. Examples of how the parameterized explanation algorithm helps improve adoption thereof within financial institutions are also disclosed. A verification that the investor-company matching algorithm with parameterized explanatory engine is fair and not biased based on a personal profile of a management team or location of company/investor is also disclosed.

In an exemplary embodiment, the company-specific data set used contains various details of startup companies, such as a brief description about what each respective company does, its industry focus, information about its previous deals such as the series raised, and amount of capital raised in that series. Similarly, for the investor-specific data set, certain characteristic information about the investors is included, such as the respective funding style and industry preference of each investor. Finally, a historical binary investor-company link matrix is also utilized.

The features of these data set are described in more detail below:

Company Data: The company features include its description, industry focus, year founded, location, and other suitable company-specific information. For instance, with respect to a company with a fictitious company name ABC Lane, the data set includes: 1) Description: Operator of a consumer finance firm intended to help consumers have access to fair and clear credit. The company leverages advanced technology, data analytics, and machine learning to provide a dignified customer experience to people who are working hard to build or rebuild their credit and have terms that are better and easier to understand than most of the alternatives available to people with less-than-pristine credit or limited credit history, enabling consumers to access credit. 2) Industry Focus: Financial Services/Other Financial Services/Consumer Finance/Financial Software. 3) Year Founded: 2018. 4) Location: Atlanta, Ga., United States.

Deals: The details regarding the capital raises done by the company include the type of series rounds that the company has gone through, when were the deals made, the amount of capital raised in each round, and any other suitable deal-related information. For instance, some of the information on the deals done by the company ABC Lane include the following: 1) Types of Series Rounds: Seed round, Series A round. 2) Amount Raised: Approximately $50 million. 3) Deal Dates: Year 2018 and Year 2019.

Investor Data: In an exemplary embodiment, the investor features are derived from the data set being used, including investor-specific funding preferences, industry preferences, locations, and any other suitable investor-specific information. For instance, features on one of the investors of the fictitiously named ABC Group of company ABC Lane include: 1) Funding Style: Mostly involved in initial stage of funding, specifically, invested 27%, 23% and 20% of the time in Seed, Series A and Series B rounds respectively and the remaining in later stages of capital raise. 2) Industry Preferences: Mostly involved in healthcare and consumer products and services, specifically, invested 56% and 20% of the time in Healthcare and Consumer Products and Services respectively and the remaining in other sectors such as Information Technology and Business Products and Services. 3) Location: New York, N.Y., United States.

Historical Investor-Company Link Matrix: In an exemplary embodiment, this binary link matrix contains historical information on whether an investor i has invested in a company j or not.

In an exemplary embodiment, in order to test the investor-company link matching algorithm, the historical investor-company link matrix is divided into 70% training and 30% test set. Given that the model is unsupervised in nature, two types of test sets are used: 1) Test Set containing Historical Links: This set contains a list of investor/company pairings for which there is historical information that there is a preexisting link between the investors and companies, i.e., the investors have invested in the companies historically. In this case, it would be expected that an ideal model would predict 100% links between the investors and companies. 2) Test Set without Historical Links: This set contains a set of randomly chosen investor/company pairings for which there is information that there is no preexisting link between the investors and companies, i.e., the investors have not invested in these companies in the past. In this case, it is expected that the model would predict no links between the investors and companies for majority of the time and predict that link might exist for some percentage of the data set, which would then become recommendations to the investors or companies.

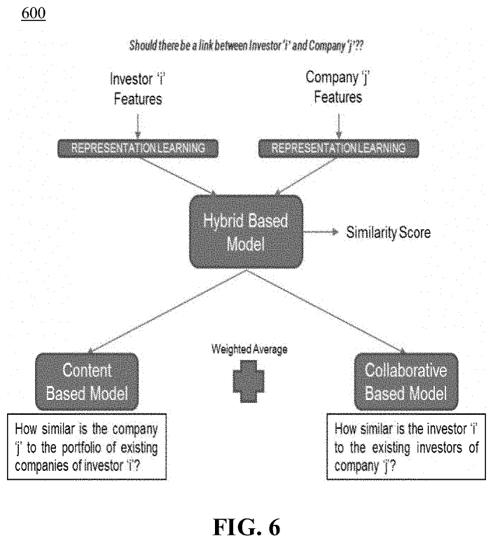

Investor/Company Matching: In an exemplary embodiment, a matching algorithm is used to match the companies to investors and vice versa, based on historical track records and preferences. FIG. 6 is an illustration 600 of an approach that is taken by a method for automating a process of matching investors with companies by using a parameterized explanation generation engine in combination with an artificial intelligence (AI)-based algorithm that implements a deep learning technique, according to an exemplary embodiment.

In an exemplary embodiment, FIG. 6 illustrates a proposed approach to solve the investor company matching problem, i.e., should there be a link between an investor i and company j? The proposed approach includes two sequential steps. In the first step, high-dimensional vector representations are generated for each company and investor from the given unstructured text that defines the attributes/features of the each respective company and each respective investor. Subsequently, in the second step, these vector representations are used to calculate respective similarity metrics between companies and investors using a hybrid approach that estimates the final similarity score by calculating a weighted average of similarity scores obtained from content-based and collaborative-based approaches.

Representation Learning: Each investor and company is characterized by multiple attributes, many of which are manifested as sequences of unstructured text. To facilitate a performance of comparisons and estimations of how close and/or how far various companies and investors are from one another, initially a high-dimensional vector representation is generated for each company and investor. In an exemplary embodiment, the key guiding principle behind the structured high-dimensional vector representation is that similar sentences, words, and/or phrases within similar contexts should map relatively close to each other in a high-dimensional space, and sentences, words, and/or phrases that are very different should be relatively far away from each other.

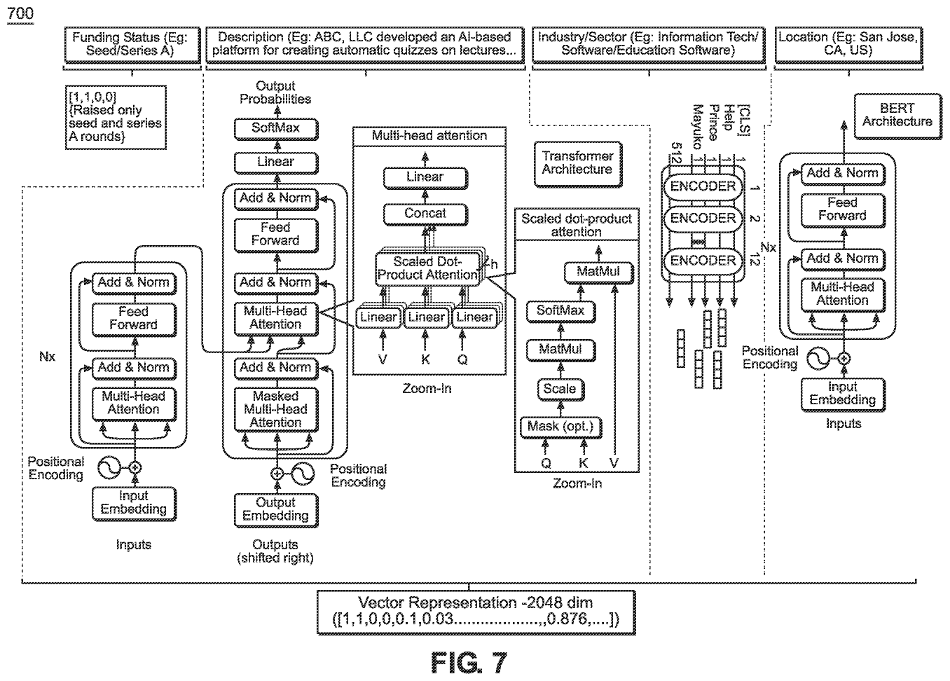

FIG. 7 is an illustration 700 of how companies and investors are depicted by using vector representations in a method for automating a process of matching investors with companies by using a parameterized explanation generation engine in combination with an artificial intelligence (AI)-based algorithm that implements a deep learning technique, according to an exemplary embodiment. FIG. 7 depicts in detail how the various different kinds of unstructured text are encoded in a high-dimensional distributed vector representation to generate one final representation for each company and/or investor.

Company Representation: In an exemplary embodiment, a company is represented by its funding status, description, industry focus and location. The methods used to build a vector representation for each attribute include the following: 1) Funding Status: This attribute describes in which types of round of raises the company has previously been involved. This feature is being represented as a Multi-Label Binarizer. For instance, if a company has only been involved in Seed and Series A rounds in the set of Seed Round, Series A, Series B, Series C, this feature will be represented as [1,1,0,0]. 2) Description: This attribute describes the business in which the company is involved. Since the position of the words in the description is important, a transformer with self-attention-based architecture may be leveraged to encode the description into a 768-dimensional dense vector representation. 3) Industry Focus: This attribute describes the type of industry in which the company operates. Since the position of words is not crucial, a Bidirectional Encoder Representations from Transformers (BERT)-based architecture may be used to create 768-dimensional vector embeddings. 4) Location: This attribute describes the city, state and country in which the company is located. Similarly as with the industry focus attribute, a BERT-based architecture may be used to create 768-dimensional vector embeddings. 5) Finally, the vector representations of the above attributes are concatenated together to form a full vector representation for the company.

Investor Representation: In an exemplary embodiment, the attributes that are used to represent an investor include funding style, industry preference and location. The methods used to build a vector representation for each attribute include the following: 1) Funding Style: This attribute describes the amount of deals that the investor has done in each type of round raise. For instance, if an investor has invested 80, 10 and 10 times in Seed, Series A and Series B rounds in the set of Seed Round, Series A, Series B, Series C, then this feature will be represented as [0.8, 0.1, 0.1, 0]. 2) Industry Preference: This attribute describes the amount of deals that the investor has done in various industry sectors. In an exemplary embodiment, in order to build the representation for this attribute, as described in company representation, the industry sectors are first encoded using a BERT-based architecture and then the weighted average of these representations are obtained with weights corresponding to number of deals that the investor has done in each industry sector. 3) Location: This attribute describes the city, state and country in which the investor is located. Similar to company representation, a BERT-based architecture may be been used to create 768-dimensional vector embeddings. 4) Finally, the vector representations of the above attributes are concatenated together to form a full vector representation for the investor.

Similarity Score Estimation: Given the high-dimensional distributed representations for both companies and investors, it becomes relatively easy to estimate the closeness or remoteness between pairs of companies and/or investors by following a hybrid approach, i.e., a weighted average of content-based and collaborative-based similarity scores. In an exemplary embodiment, a proposed similarity estimation method includes the following key steps:

1) Content-based Model: In an exemplary embodiment, a content-based approach uses the attributes and features of the companies to recommend similar companies to an investor. This model recommends a company to an investor based on its existing portfolio of companies. This method relies only on company features and not on any investor preferences. Formally, for a company j, the intention is to estimate which company and with what score is it closest to in the portfolio of companies in which investor i has previously invested.

2) Collaborative-based Model: In an exemplary embodiment, a collaborative-based approach generates recommendations by deriving an investor's historical preferences with respect to companies. This model recommends an investor to a company based on its existing portfolio of investors. This method relies only on the historical interaction between the investors and companies as well as historical preferences of the investors, and not on company features. Formally, for an investor i, the intention is to determine which investor and with what score is it closest to in the portfolio of previous investors of company j.

It may be noted that since the investor-company interaction matrix is very sparse, using only one of the above similarity scores may lead to performance degradation. To overcome this, in an exemplary embodiment, the final score is determined as a weighted average score from the results of the content-based model and the collaborative-based model as described above. In particular, combining these models helps overcome the performance degradation caused by the sparse historical interaction between the investors and companies, and it also helps alleviate cold-start problems which may arise when investors have no or very few interactions or for new companies who have not raised any funding round or interacted with any investors.

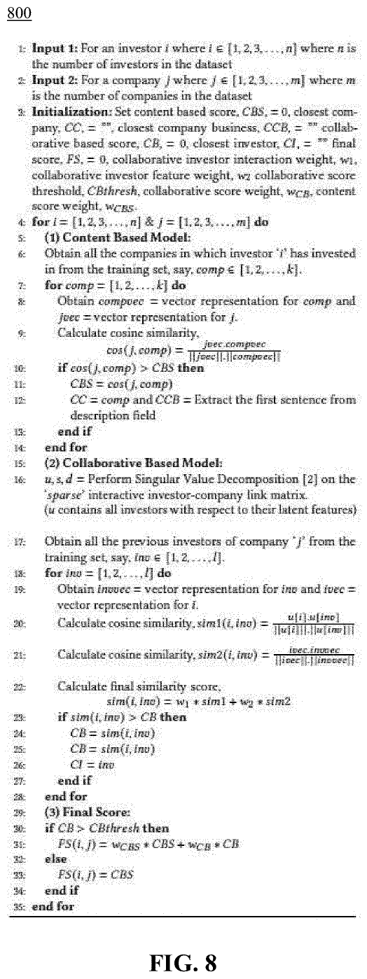

FIG. 8 is a step-by-step description 800 of a matching algorithm that is used in a method for automating a process of matching investors with companies by using a parameterized explanation generation engine in combination with an artificial intelligence (AI)-based algorithm that implements a deep learning technique, according to an exemplary embodiment. Referring to FIG. 800, the description 800 describes an overall matching algorithm in a step-by-step manner.

Results: The following is a description of the performance of the proposed matching algorithm on an exemplary data set containing 40,000 historical investor company links. As discussed above, in an exemplary embodiment, 70% of the historical investor-company links are used as part of a training set and the remaining 30% are used as the test set. Also, it may be noted that the results shown are based on a threshold that is set at 0.75, i.e., any time the similarity score is greater than 0.75, it is considered that a link exists between the respective company/investor pairing, and if the similarity score is less than 0.75, then it is considered that no link exists.

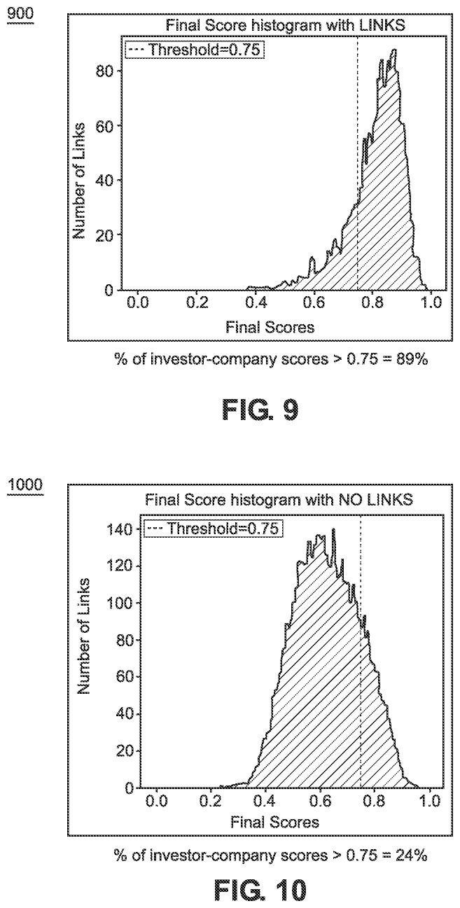

FIG. 9 is a histogram 900 of similarity scores for a situation in which historical links exist between paired companies and investors, as determined by applying a method for automating a process of matching investors with companies by using a parameterized explanation generation engine in combination with an artificial intelligence (AI)-based algorithm that implements a deep learning technique, according to an exemplary embodiment. FIG. 10 is a histogram 1000 of similarity scores for a situation in which historical links do not exist between paired companies and investors, as determined by applying a method for automating a process of matching investors with companies by using a parameterized explanation generation engine in combination with an artificial intelligence (AI)-based algorithm that implements a deep learning technique, according to an exemplary embodiment.

FIG. 9 shows the histogram 900 of the final similarity score obtained on the test set for which it is known that the ground-truth is that a link between the company and investor pairing exists. As expected, in this case, the histogram 900 of similarity scores is skewed to the right, and the model correctly predicts that there should be links between the investors and companies for 89% of the test set.

FIG. 10 shows a similar similarity-score histogram 1000 for a test set that contains randomly chosen company/investor pairings, and for which it is known that the ground truth is that there is no historical link between the company/investor pairing. As expected, the histogram 1000 is skewed to the left, and the model predicts that there should be links between the investors and companies only for 24% of the test set. It may be noted that even an ideal model should have a small percentage of investor/company pairings for which it predicts that a link should exist, because these become the model's recommendations to investors and/or companies.

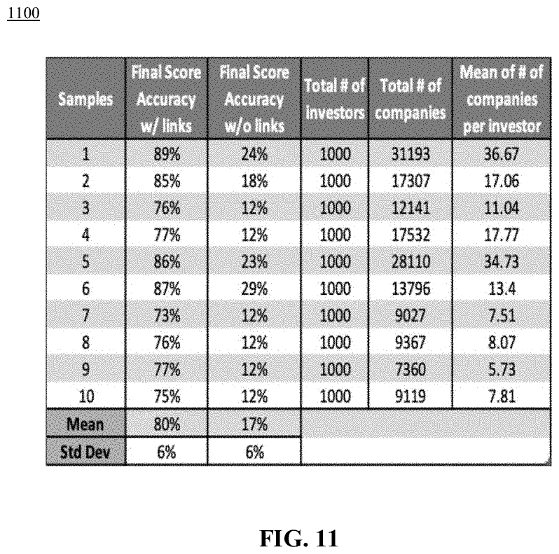

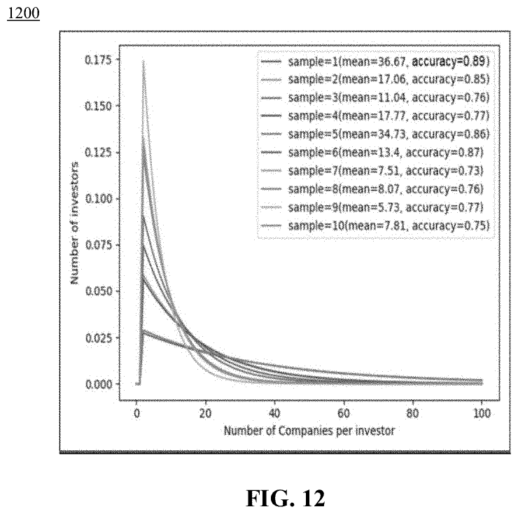

FIG. 11 is a chart 1100 that shows results of a stability analysis of a method for automating a process of matching investors with companies by using a parameterized explanation generation engine in combination with an artificial intelligence (AI)-based algorithm that implements a deep learning technique, according to an exemplary embodiment. FIG. 12 is a graph 1200 that illustrates the stability analysis information of FIG. 11.

In order to test the stability of the matching algorithm, ten (10) independent samples were obtained from the test data set, each containing 1000 investors. FIG. 11 shows the performance of the model over these samples. The column labeled “Final Score Accuracy w/Links” estimates the accuracy in correctly predicting a link when the ground-truth link exists. Also, the column labeled “Final score Accuracy w/o links” measures the percentage of companies for which a score that is above the pre-set threshold is obtained when it is known that underlying data has no links, i.e., historically no link has existed between the company and investor pairing. As disclosed above, it is expected that this relatively low percentage of cases actually constitute the model's recommendations, and while this percentage should be low, this should not be very close to zero, because otherwise very few recommendations would ever be made.

Referring again to FIG. 11, the model has a good stability with a mean of 80% performance and standard deviation of only 6% for the test sets where there are existing historical links between the investors and companies. In case of the test set containing randomly chosen companies for which there is information that links do not exist between the investors and companies, the model is stable with a mean of 17% performance and standard deviation of only 6%.

Referring to FIG. 12, in order to further analyze the standard deviation of 6%, an exponential graph 1200 was constructed to observe how the performance of the model varies over these 10 independent samples with respect to the portfolio of mean number of companies per investor. As can be observed in FIG. 12, the more the mean number of companies per investor, the better the performance of the model is, i.e., when there are more historical track records and/or preferences and investor-company interaction links present, then the model recommendations tend to be correspondingly better.

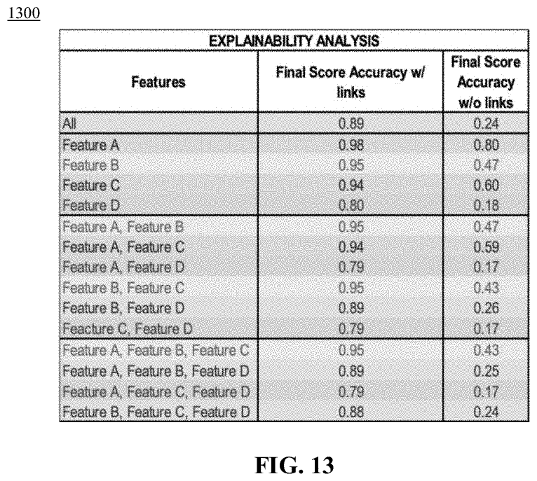

FIG. 13 is a chart 1300 that shows information that corresponds to an explainability analysis with respect to a method for automating a process of matching investors with companies by using a parameterized explanation generation engine in combination with an artificial intelligence (AI)-based algorithm that implements a deep learning technique, according to an exemplary embodiment.

In an exemplary embodiment, in order to test the importance of the company features that are being used, the model is further tested by taking one feature at a time. An analysis of the model may also be performed over pairs of features as well as triplets of features. The results are based on the same data set of 40,000 historical investor-company links with a threshold set at 0.75. As can be observed in FIG. 13, the features B and D of the company are the key driving features of the model. Also, individually, feature B brings noise in the results and feature D is very hard on the results. The combination of these two features brings the model performance very close to the performance of the model while using all the company features. Finally, a verification analysis has been performed, thereby confirming that the investor-company matching algorithm is fair and that it is not biased based on either the personal profile of the management team or the respective locations of the company and/or the investor.

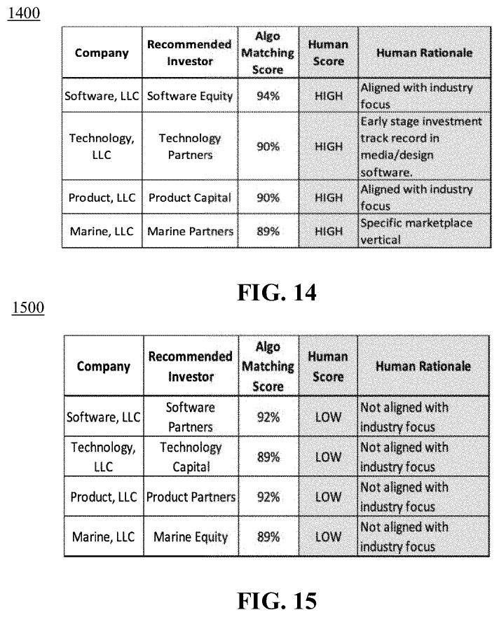

FIG. 14 is a chart 1400 that shows results of human analysis with high scores as determined by executing a method for automating a process of matching investors with companies by using a parameterized explanation generation engine in combination with an artificial intelligence (AI)-based algorithm that implements a deep learning technique, according to an exemplary embodiment. FIG. 15 is a chart 1500 that shows results of human analysis with low scores as determined by executing a method for automating a process of matching investors with companies by using a parameterized explanation generation engine in combination with an artificial intelligence (AI)-based algorithm that implements a deep learning technique, according to an exemplary embodiment.

Human Analysis: In order to analyze the relevance of the recommendations produced by the model, 25 investor recommendations for four fictitiously named companies including Software, LLC; Technology, LLC; Product, LLC; and Marine, LLC were provided to subject matter experts (SMEs) for review. Out of these 100 investor-company matching pairs, 65 pairs were confirmed as relevant by the SMEs. FIG. 14 shows an example of the investor recommendation for each of the four companies for which the SMEs/humans gave a high score based on their own independent rationales.

For 35 pairs, the SMEs/humans gave a low score, and in these cases, the SMEs indicated that in their view, the computer-generated recommendations may not be relevant. FIG. 15 shows an example of the investor recommendation for each of the four companies for which the SMEs/humans gave a low score along with their rationale for low score. Subsequently, a parameterized explanatory algorithm according to an exemplary embodiment was used to algorithmically generate explanations, as to why the particular recommendation had been made. Following the explanations, the subject matter experts were convinced that the recommendations are indeed correct, and assigning them a low human score was actually due to limited breadth of human knowledge.

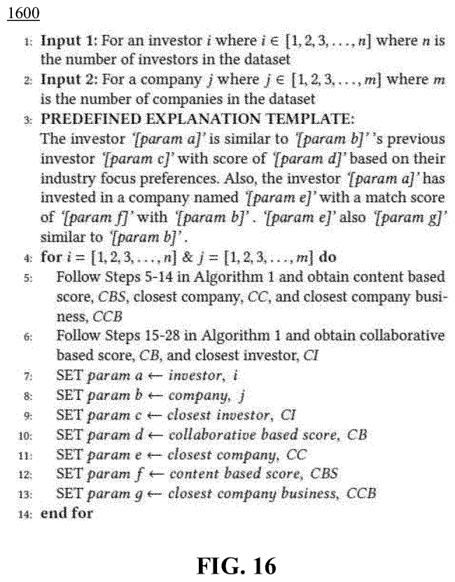

Parameterized Explanatory Algorithm: As discussed above, in an exemplary embodiment, the ability to explain why a particular recommendation has been made is an essential requirement for the model, and is critical to ensure adoption of the model. FIG. 16 is a step-by-step description 1600 of a parameterized explanatory algorithm that is used in a method for automating a process of matching investors with companies by using a parameterized explanation generation engine in combination with an artificial intelligence (AI)-based algorithm that implements a deep learning technique, according to an exemplary embodiment.

In an exemplary embodiment, the algorithm shown in FIG. 16 describes a parameterized explanatory algorithm in a step-by-step manner. In this algorithm, there is a predefined written template, and the parameters of the template are selected and filled using the intermediary results obtained from the matching algorithm. In order to explain the recommendation score between an investor i and a company j, the explanation generated includes three parts: 1) Investor-Investor Similarity: This first part clarifies that the investor i is most similar to which of the previous investors of company j and with how much score. 2) Company-Company Similarity: This second part clarifies that the company j is most similar to which of the investor i's portfolio of existing invested companies and with how much score. 3) Company Description: This third part shows the key business area that the company, which is the most similar to company j, works on and is hence similar to company j. This company description gives a more detailed explanation at the feature level as to why there is a recommendation of a link between the investor i and the company j.

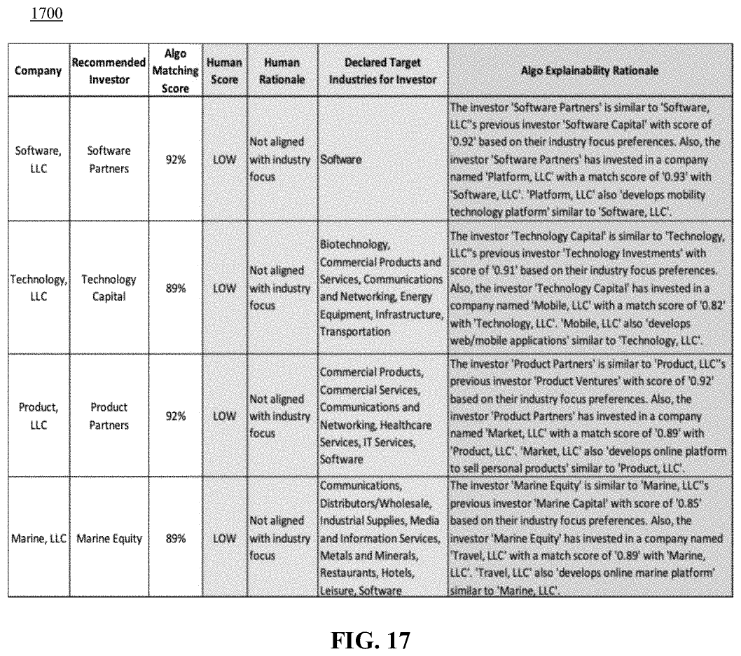

Results: FIG. 17 is a chart 1700 that shows example results of the parameterized explanatory algorithm of FIG. 16. For instance, in order to explain the high recommendation score between the company Software, LLC and investor Software Partners, the three-part explanation includes the following: 1) Investor-Investor Similarity: This part clarifies that investor Software Partners is similar to the company Software, LLC's previous investor Software Capital with a score of 0.92. 2) Company-Company Similarity: This part clarifies that the company Software, LLC is most similar to the company Platform, LLC with a score of 0.93. Platform, LLC is one of the companies in which Software Partners has previously invested. 3) Company Description: This part clarifies that both Software, LLC and Platform, LLC develop mobility technology platforms.

The matched investor-company pairings that were provided to the subject matter experts (SMEs) for review, as described above, were again submitted with these explanations for review. The SMEs accepted the explanations and were convinced that all the recommendations that were provided by the algorithm are relevant.

Accordingly, with this technology, a process for automating a process of matching investors with companies by using a parameterized explanation generation engine in combination with an artificial intelligence (AI)-based algorithm that implements a deep learning technique is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating a recommendation for a potential investment, the method being implemented by at least one processor, the method comprising:
receiving, by the at least one processor, first information that relates to each respective company from among a plurality of companies;
generating, for each respective company based on the first information by the at least one processor, a first vector representation;
receiving, by the at least one processor, second information that relates to each respective investor from among a plurality of investors;
generating, for each respective investor based on the second information by the at least one processor, a second vector representation;
using, by the at least one processor, the first vector representations and the second vector representations to calculate a respective similarity metric for each respective pair of one company from among the plurality of companies and one investor from among the plurality of investors;
generating, by the at least one processor, the recommendation for the potential investment based on the calculated similarity metrics; and
generating, by the at least one processor, an explanation that includes at least one reason that relates to the recommendation.

2. The method of claim 1, wherein the first information includes, for each respective company, at least one from among a description, an industry focus, a year during which the respective company was founded, and a location.

3. The method of claim 2, wherein for at least one respective company from among the plurality of companies, the first information further includes information that relates to at least one deal executed by the at least one respective company, including at least one from among a type of series rounds performed by the at least one respective company, an amount of capital raised, and a date of the at least one deal.

4. The method of claim 1, wherein the second information includes, for each respective investor, at least one from among information that relates to a funding style, information that relates to an industry preference, and a location.

5. The method of claim 1, wherein the using of the first vector representations and the second vector representations to calculate each respective similarity metric comprises applying an artificial intelligence (AI)-based algorithm that determines, for each respective pair of one company from among the plurality of companies and one investor from among the plurality of investors, a first score that is based on a content-based model and a second score that is based on a collaborative-based model, and then calculates the respective similarity metric by combining the first score with the second score.

6. The method of claim 5, wherein the determining of the first score comprises calculating a cosine similarity function based on the first vector representation of the one company and respective first vector representations that correspond to companies in which the one investor has previously invested.

7. The method of claim 5, wherein the determining of the second score comprises calculating a cosine similarity function based on the second vector representation of the one investor and respective second vector representations that correspond to investors that have previously invested in the one company.

8. The method of claim 5, wherein the calculating of the respective similarity metric further comprises:
when the second score exceeds a predetermined threshold, multiplying the first score by a predetermined first weight to obtain a first product and multiplying the second score by a predetermined second weight to obtain a second product and then adding the first product to the second product; and
when the second score does not exceed the predetermined threshold, using the first score as the respective similarity metric.

9. The method of claim 1, wherein the generating of the explanation comprises:
determining a first partial explanation based on a similarity between the one investor and at least one other investor that has previously invested in the one company;
determining a second partial explanation based on a similarity between the one company and at least one other company in which the one investor has previously invested;
determining a third partial explanation based on a description of the one company; and
generating the explanation based on a combination of the first partial explanation, the second partial explanation, and the third partial explanation.

10. A computing apparatus for generating a recommendation for a potential investment, the computing apparatus comprising:
a processor;
a memory; and
a communication interface coupled to each of the processor and the memory,
wherein the processor is configured to:
receive, via the communication interface, first information that relates to each respective company from among a plurality of companies;
generate, for each respective company based on the first information, a first vector representation;
receive, via the communication interface, second information that relates to each respective investor from among a plurality of investors;
generate, for each respective investor based on the second information, a second vector representation;
use the first vector representations and the second vector representations to calculate a respective similarity metric for each respective pair of one company from among the plurality of companies and one investor from among the plurality of investors;
generate the recommendation for the potential investment based on the calculated similarity metrics; and
generate an explanation that includes at least one reason that relates to the recommendation.

11. The computing apparatus of claim 10, wherein the first information includes, for each respective company, at least one from among a description, an industry focus, a year during which the respective company was founded, and a location.

12. The computing apparatus of claim 11, wherein for at least one respective company from among the plurality of companies, the first information further includes information that relates to at least one deal executed by the at least one respective company, including at least one from among a type of series rounds performed by the at least one respective company, an amount of capital raised, and a date of the at least one deal.

13. The computing apparatus of claim 10, wherein the second information includes, for each respective investor, at least one from among information that relates to a funding style, information that relates to an industry preference, and a location.

14. The computing apparatus of claim 10, wherein the processor is further configured to calculate each respective similarity metric by applying an artificial intelligence (AI)-based algorithm that determines, for each respective pair of one company from among the plurality of companies and one investor from among the plurality of investors, a first score that is based on a content-based model and a second score that is based on a collaborative-based model, and then calculates the respective similarity metric by combining the first score with the second score.

15. The computing apparatus of claim 14, wherein the processor is further configured to determine the first score by calculating a cosine similarity function based on the first vector representation of the one company and respective first vector representations that correspond to companies in which the one investor has previously invested.

16. The computing apparatus of claim 14, wherein the processor is further configured to determine the second score by calculating a cosine similarity function based on the second vector representation of the one investor and respective second vector representations that correspond to investors that have previously invested in the one company.

17. The computing apparatus of claim 14, wherein the processor is further configured to calculate the respective similarity metric by:
when the second score exceeds a predetermined threshold, multiplying the first score by a predetermined first weight to obtain a first product and multiplying the second score by a predetermined second weight to obtain a second product and then adding the first product to the second product; and
when the second score does not exceed the predetermined threshold, using the first score as the respective similarity metric.

18. The computing apparatus of claim 10, wherein the processor is further configured to generate the explanation by:
determining a first partial explanation based on a similarity between the one investor and at least one other investor that has previously invested in the one company;
determining a second partial explanation based on a similarity between the one company and at least one other company in which the one investor has previously invested;
determining a third partial explanation based on a description of the one company; and
generating the explanation based on a combination of the first partial explanation, the second partial explanation, and the third partial explanation.

19. A non-transitory computer readable storage medium storing instructions for generating a recommendation for a potential investment, the storage medium comprising executable code which, when executed by a processor, causes the processor to:
receive first information that relates to each respective company from among a plurality of companies;
generate, for each respective company based on the first information, a first vector representation;
receive second information that relates to each respective investor from among a plurality of investors;
generate, for each respective investor based on the second information, a second vector representation;
use the first vector representations and the second vector representations to calculate a respective similarity metric for each respective pair of one company from among the plurality of companies and one investor from among the plurality of investors;
generate the recommendation for the potential investment based on the calculated similarity metrics; and
generate an explanation that includes at least one reason that relates to the recommendation.

20. The storage medium of claim 19, wherein the first information includes, for each respective company, at least one from among a description, an industry focus, a year during which the respective company was founded, and a location.
